(19) United States
(12) Patent Application Publication
(10) Pub. No.: US 2018/0024728 A1
(43) Pub. Date: Jan. 25, 2018

(54) Terminal and Terminal Wallpaper Control Method

(71) Applicant: Huawei Technologies Co., Ltd., Shenzhen (CN)

(72) Inventor: Liang Cheng, Beijing (CN)

(21) Appl. No.: 15/547,750

(22) PCT Filed: Jan. 30, 2015
(86) PCT No.: PCT/CN2015/072053

§ 371 Date: Jul. 31, 2017

(51) Int. Cl. G06F 3/0484; G06F 3/0488; G06T 11/60; H04B 1/3827

(52) U.S. Cl. CPC G06F 3/04845; H04B 1/3833; G06F 3/04883; G06T 11/60; G06T 11/001

(57) ABSTRACT

A terminal and a terminal wallpaper control method, applied to a terminal equipped with a touchscreen, includes when the terminal detects a flick operation on the touchscreen and the flick operation meets a preset condition, the terminal changes, corresponding to the flick operation, display content of a random N % zone in wallpaper displayed on the touchscreen, where display content of another zone in the wallpaper except the N % zone remains unchanged, and N is an integer greater than or equal to 1 and less than 100, and when the terminal detects that the flick operation stops, changing display content of the wallpaper is stopped, and a changed N % zone and a 100−N % zone that remains unchanged are presented.

### CROSS-REFERENCE TO RELATED APPLICATION

This application is a U.S. National Stage of International Patent Application No. PCT/CN2015/072053 filed on Jan. 30, 2015, which is hereby incorporated by reference in its entirety.

### TECHNICAL FIELD

The present disclosure relates to the communications field, and in particular, to a terminal and a terminal wallpaper control method.

### BACKGROUND

Currently, desktop static wallpaper that is set by a terminal is usually a planar image. The image may be an image having a same size as a screen, and remain unchanged when the screen is flicked left and right, or may be an image wider than the screen, and move accordingly when the screen is flicked left and right. For a user, visible wallpaper remains unchanged.

### SUMMARY

Embodiments of the present disclosure provide a terminal and a terminal wallpaper control method, which may present different display effects on static wallpaper that is set by the terminal.

To achieve the foregoing objective, the following technical solutions are adopted in the embodiments of the present disclosure.

According to a first aspect, a terminal wallpaper control method is disclosed, and the method is applied to a terminal equipped with a touchscreen, and includes changing, by the terminal corresponding to the flick operation, display content of a random N % zone in wallpaper displayed on the touchscreen when the terminal detects a flick operation on the touchscreen and the flick operation meets a preset condition, where display content of another zone in the wallpaper except the N % zone remains unchanged, and N is an integer greater than or equal to 1 and less than 100, and when the terminal detects that the flick operation stops, stop changing display content of the wallpaper, and presenting a changed N % zone and a 100−N % zone that remains unchanged.

With reference to the first aspect, in a first possible implementation manner of the first aspect, changing, by the terminal corresponding to the flick operation, display content of a random N % zone in wallpaper displayed on the touchscreen further includes randomly changing, by the terminal, the wallpaper to another piece of wallpaper.

With reference to the first aspect, in a second possible implementation manner of the first aspect, changing, by the terminal corresponding to the flick operation, display content of a random N % zone in wallpaper displayed on the touchscreen further includes randomly changing, by the terminal, at least one of the following parameters of the N % zone: a shape, a color, a size, or a location, and displaying a process of a dynamic change of the N % zone.

With reference to the first aspect, in a third possible implementation manner of the first aspect, changing, by the terminal corresponding to the flick operation, display content of a random N % zone in wallpaper displayed on the touchscreen further includes randomly changing, by the terminal, at least one of the following parameters of the N % zone: a shape, a color, a size, or a location, displaying a process of a dynamic change of the N % zone, and adding a dynamic display pattern to the wallpaper.

With reference to the first aspect, in a fourth possible implementation manner of the first aspect, randomly changing, by the terminal corresponding to the flick operation, display content of a random N % zone in wallpaper displayed on the touchscreen further includes changing, by the terminal, the wallpaper to random new wallpaper, and adding a dynamic display pattern to the new wallpaper.

According to a second aspect, a terminal is disclosed, where the terminal is equipped with a touchscreen and includes a detection unit configured to detect whether a flick operation exits on the touchscreen, and determine, when detecting the flick operation, whether the flick operation meets a preset condition, and a display control unit configured to change, corresponding to the flick operation, display content of a random N % zone in wallpaper displayed on the touchscreen when the detection unit detects the flick operation on the touchscreen and the flick operation meets the preset condition, where display content of another zone in the wallpaper except the N % zone remains unchanged, and N is an integer greater than or equal to 1 and less than 100, and when the detection unit detects that the flick operation stops the display control unit is further configured to stop changing display content of the wallpaper, and present a changed N % zone and a 100−N % zone that remains unchanged.

With reference to the second aspect, in a first possible implementation manner of the second aspect, the display control unit is further configured to randomly change the wallpaper to another piece of wallpaper.

With reference to the second aspect, in a second possible implementation manner of the second aspect, the display control unit is further configured to change at least one of the following parameters of the N % zone: a shape, a color, a size, or a location, and display a process of a dynamic change of the N % zone.

With reference to the second aspect, in a third possible implementation manner of the second aspect, the display control unit is further configured to randomly change at least one of the following parameters of the N % zone: a shape, a color, a size, or a location, display a process of a dynamic change of the N % zone, and add a dynamic display pattern to the wallpaper.

With reference to the second aspect, in a fourth possible implementation manner of the second aspect, the display control unit is further configured to change the wallpaper to random new wallpaper, and add a dynamic display pattern to the new wallpaper.

According to the terminal and the terminal wallpaper control method that are provided in the present disclosure, when the terminal detects a flick operation on a touchscreen and the flick operation meets a preset condition, the terminal changes, corresponding to the flick operation, display content of a random N % zone in wallpaper displayed on the touchscreen, where display content of another zone in the wallpaper except the N % zone remains unchanged. When the terminal detects that the flick operation stops, changing display content of the wallpaper is stopped, and a changed N % zone and a 100−N % zone that remains unchanged are presented. Therefore, different wallpaper may be presented for a user according to a user operation, and a changed zone and a color are different each time the user flicks a screen. Different display effects are presented on static wallpaper that is set by the terminal.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of a terminal wallpaper control method according to Embodiment 1 of the present disclosure;

FIG. 2A is a schematic diagram of terminal wallpaper before change according to Embodiment 1 of the present disclosure;

FIG. 2B is an effect diagram of wallpaper changing according to Embodiment 1 of the present disclosure;

FIG. 2C is another effect diagram of wallpaper changing according to Embodiment 1 of the present disclosure;

FIG. 2D is another effect diagram of wallpaper changing according to Embodiment 1 of the present disclosure;

FIG. 2E is another effect diagram of wallpaper changing according to Embodiment 1 of the present disclosure;

FIG. 3 is a schematic flowchart of a terminal wallpaper control method according to Embodiment 2 of the present disclosure;

FIG. 4 is an effect diagram of wallpaper changing according to Embodiment 2 of the present disclosure;

FIG. 5 is another effect diagram of wallpaper changing according to Embodiment 2 of the present disclosure;

FIG. 6 is a structural diagram of a terminal according to Embodiment 3 of the present disclosure; and

FIG. 7 is a structural diagram of a terminal according to Embodiment 4 of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

### Embodiment 1

This embodiment of the present disclosure provides a terminal wallpaper control method, and the method is applied to a terminal equipped with a touchscreen. As shown in FIG. 1, the method includes the following steps.

Step 101: When the terminal detects a flick operation on the touchscreen and the flick operation meets a preset condition, the terminal changes, corresponding to the flick operation, display content of a random N % zone in wallpaper displayed on the touchscreen, where display content of another zone in the wallpaper except the N % zone remains unchanged, and N is an integer greater than or equal to 1, and less than or equal to 100.

The flick operation is an operation generated on a terminal screen by a point-and-click object. The point-and-click object may be a finger of a user, or may be a stylus that is delivered with the terminal, which is not limited herein. It should be noted that, that the flick operation meets a preset condition may be performing determining on flick displacement generated by the flick operation, and determining whether the flick displacement meets the preset condition. Displacement is a vector, that is, has a size and a direction, and a direction of the displacement points from a start point to an end point. Here, because a direction of the flick displacement is a direction in which the user flicks the touchscreen, a start point of the flick displacement is a start point of this flick operation of a point-and-click object, and an end point is a current touch point of the point-and-click object on the touchscreen or a touch point of the user on the touchscreen. Because flick displacement of the point-and-click object on the touchscreen needs to be obtained in real time, an end point of the flick displacement is a current touch point of the point-and-click object. Therefore, when flick displacement of the user meets a preset condition, for example, the displacement is greater than a preset threshold, wallpaper may change with a flick operation of the point-and-click object.

It should be noted that, that the terminal changes, corresponding to the flick operation, display content of a random N % zone in wallpaper displayed on the touchscreen further includes the following several implementation manners.

1. Change the wallpaper to new wallpaper. The new wallpaper has a different N % zone compared with the wallpaper (current wallpaper).

2. The terminal randomly changes at least one of the following parameters of the N % zone: a shape, a color, a size, or a location, and displays a process of a dynamic change of the N % zone.

Exemplarily, when flick displacement generated when a user uses the point-and-click object to flick the touchscreen meets the preset condition, old elements in N sub-zones in the wallpaper are replaced by new elements, and a process of a dynamic change such as chipping, falling, or drifting is displayed.

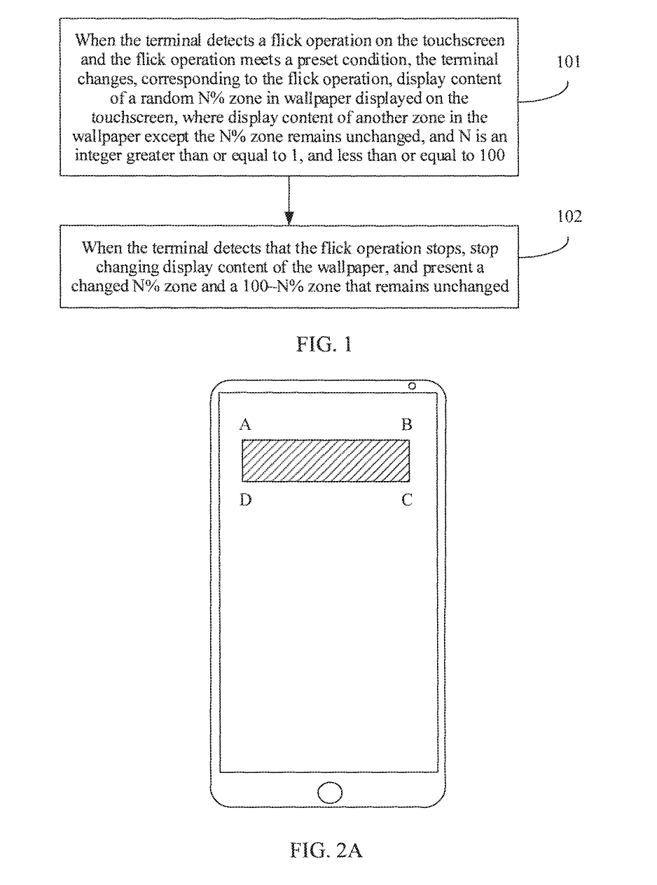

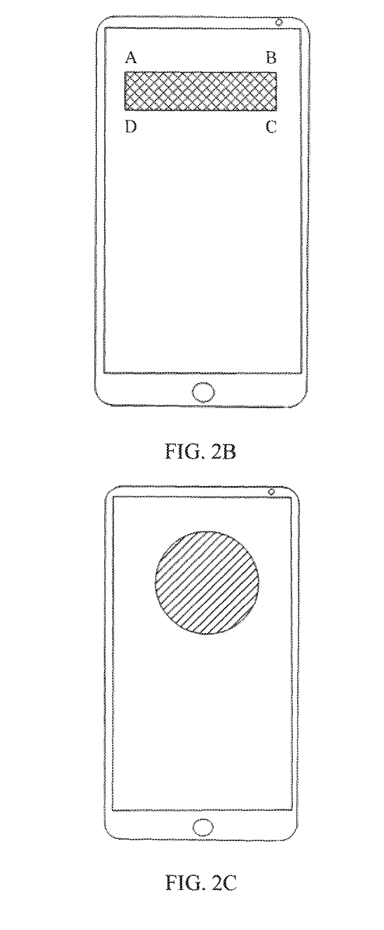

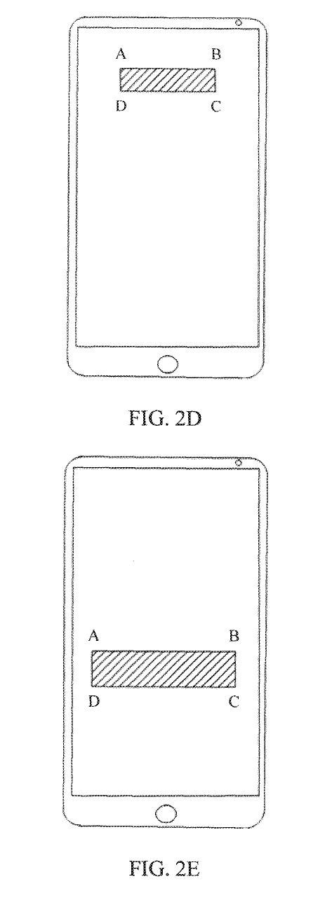

As shown in FIG. 2A, a rectangle ABCD is a zone whose area is N % in terminal wallpaper. A color of the rectangle ABCD may be changed according to a detected flick operation. When it is detected that the flick operation stops, as shown in FIG. 2B, display content of the wallpaper is a rectangle ABCD whose color is changed. Certainly, a shape of the rectangle ABCD may be changed according to the detected flick operation. When it is detected that the flick operation stops, as shown in FIG. 2C, display content of the wallpaper is a circle. Alternatively, a size of the rectangle ABCD may be changed according to the detected flick operation. When it is detected that the flick operation stops, as shown in FIG. 2D, display content of the wallpaper is a rectangle ABCD whose size is changed. Alternatively, a location of the rectangle ABCD may be changed according to the detected flick operation. When it is detected that the flick operation stops, as shown in FIG. 2E, display content of the wallpaper is a rectangle ABCD whose location is changed.

3. The terminal randomly changes at least one of the following parameters of the N % zone: a shape, a color, a size, or a location, displays a process of a dynamic change of the N % zone, and adds a dynamic display pattern to the wallpaper.

The newly adding a dynamic display pattern to the wallpaper may be adding a dynamic icon such as a blinking star or a flying butterfly.

4. The terminal changes the wallpaper to random new wallpaper, and adds a dynamic display pattern to the new wallpaper.

In addition, because flick displacement generated by a flick operation is a vector, the preset condition may be that a direction meets a preset condition A and an absolute value of displacement meets a preset condition B. For example, a direction faces rightward (which is not an absolute due right direction) and an absolute value of displacement is greater than a preset value (which may be x % of a screen width), or a direction faces leftward, and an absolute value of displacement is greater than a preset value (which may be x % of a screen width). Therefore, the user uses the point-and-click object to perform different flick operations, and different changes occur in wallpaper. A reset color is also random. Certainly, the preset condition has a special meaning. When the flick operation does not meet a preset value specified in the preset condition, it may be considered that this flick operation is caused by a careless touch of the user on the screen and is not a flick operation generated when the screen of the terminal is flicked by performing a real operation.

Step 102: When the terminal detects that the flick operation stops, stop changing display content of the wallpaper, and present a changed N % zone and a 100−N % zone that remains unchanged.

When the terminal detects that the flick operation stops, wallpaper presented on the terminal is an effect of combining the changed N % zone and the unchanged 100−N % zone in step 101, which may be any one of effects shown in FIG. 2A to FIG. 2E.

According to the terminal wallpaper control method provided in the present disclosure, when the terminal detects a flick operation on the touchscreen and the flick operation meets a preset condition, the terminal changes, corresponding to the flick operation, display content of a random N % zone in wallpaper displayed on the touchscreen, where display content of another zone in the wallpaper except the N % zone remains unchanged. When the terminal detects that the flick operation stops, changing display content of the wallpaper is stopped, and a changed N % zone and a 100−N % zone that remains unchanged are presented. Therefore, different wallpaper may be presented for a user according to a user operation, and a changed zone and color are different each time the user flicks a screen. Different display effects are presented on static wallpaper that is set by the terminal.

### Embodiment 2

This embodiment of the present disclosure provides a terminal wallpaper control method, and the method is applied to a terminal equipped with a touchscreen. In this embodiment, a method for changing a color of a random N % zone in wallpaper is described. As shown in FIG. 3, the method includes the following steps.

Step 201: When the terminal detects a flick operation on the touchscreen and the flick operation meets a preset condition, the terminal sets, corresponding to the flick operation, colors of M independent zones in the wallpaper. M is an integer greater than or equal to 1, and the M independent zones are vertically distributed and mutually discontinuous.

Further, FIG. 4 shows an effect displayed on the wallpaper after step 201 is performed once.

Step 202: Repeatedly perform step 201 until a flick stops, where a j^{th} independent zone of an i^{th} setting and a j^{th} independent zone of an (i−1)^{th} setting are continuous, and jε[1,M].

Further, a changing effect of the wallpaper may be shown in FIG. 5. In the wallpaper, old elements in N sub-zones (constituted by multiple independent zones that are set by repeatedly performing step 201) are replaced by new elements, and a process of a dynamic change such as chipping, falling, or drifting is displayed.

It should be noted that N pieces of wallpaper may be set in succession (a time interval between wallpaper settings is relatively short). A color of a partial zone in each piece of wallpaper is reset, and an effect same as that displayed in FIG. 5 is achieved by setting X pieces of wallpaper in succession.

Further, in a preferred embodiment of the present disclosure, before display content of a random N % zone in wallpaper displayed on the touchscreen is changed, the method further includes resetting a value of N.

Therefore, after a user flicks a screen each time, a size of a changed zone in the wallpaper is different, and diverse wallpaper is presented for the user.

According to the terminal wallpaper control method provided in the present disclosure, when the terminal detects a flick operation on the touchscreen and the flick operation meets a preset condition, the terminal changes, corresponding to the flick operation, display content of a random N % zone in wallpaper displayed on the touchscreen, where display content of another zone in the wallpaper except the N % zone remains unchanged. When the terminal detects that the flick operation stops, changing display content of the wallpaper is stopped, and a changed N % zone and a 100−N % zone that remains unchanged are presented. Therefore, different wallpaper may be presented for a user according to a user operation, and a changed zone and color are different each time the user flicks a screen. Different display effects are presented on static wallpaper that is set by the terminal.

### Embodiment 3

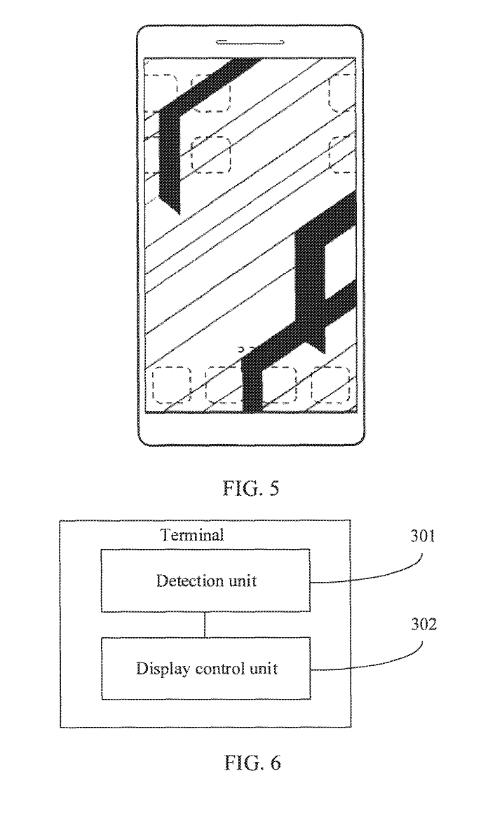

This embodiment of the present disclosure provides a terminal, where the terminal is equipped with a touchscreen. As shown in FIG. 6, the terminal includes a detection unit 301 and a display control unit 302.

The detection unit 301 is configured to detect whether a flick operation exits on the touchscreen, and determine, when detecting the flick operation, whether the flick operation meets a preset condition.

The display control unit 302 is configured to change, corresponding to the flick operation, display content of a random N % zone in wallpaper displayed on the touchscreen when the detection unit 301 detects the flick operation on the touchscreen and the flick operation meets the preset condition, where display content of another zone in the wallpaper except the N % zone remains unchanged, and N is an integer greater than or equal to 1, and less than or equal to 100.

The display control unit 302 is further configured to stop changing display content of the wallpaper, and present a changed N % zone and a 100−N % zone that remains unchanged when the detection unit 301 detects that the flick operation stops.

The display control unit 302 is further configured to randomly change the wallpaper to another piece of wallpaper.

The display control unit 302 is further configured to change at least one of the following parameters of the N % zone: a shape, a color, a size, or a location, and display a process of a dynamic change of the N % zone.

The display control unit 302 is further configured to randomly change at least one of the following parameters of the N % zone: a shape, a color, a size, or a location, display a process of a dynamic change in the N % zone, and newly add a dynamic display pattern to the wallpaper.

The display control unit 302 is further configured to change the wallpaper to random new wallpaper, and add a dynamic display pattern to the new wallpaper.

According to the terminal of terminal wallpaper provided in the present disclosure, when the terminal detects a flick operation on the touchscreen and the flick operation meets a preset condition, the terminal changes, corresponding to the flick operation, display content of a random N % zone in wallpaper displayed on the touchscreen, where display content of another zone in the wallpaper except the N % zone remains unchanged. When the terminal detects that the flick operation stops, changing display content of the wallpaper is stopped, and a changed N % zone and a 100−N % zone that remains unchanged are presented. Therefore, different wallpaper may be presented for a user according to a user operation, and a changed zone and color are different each time the user flicks a screen. Different display effects are presented on static wallpaper that is set by the terminal.

### Embodiment 4

This embodiment of the present disclosure provides a terminal 40, where the terminal 40 is equipped with a touchscreen (not shown). FIG. 7 shows a schematic structural diagram of the terminal 40 provided in this embodiment of the present disclosure. The terminal 40 provided in this embodiment of the present disclosure may be configured to implement methods implemented in the embodiments of the present disclosure shown in FIG. 1 and FIG. 3. For ease of description, only a part related to this embodiment of the present disclosure is shown. For specific technical details that are not disclosed, refer to the embodiments of the present disclosure shown in FIG. 1 and FIG. 3.

The terminal 40 may be a terminal device, such as a mobile phone, a tablet computer, a notebook computer, an ultra-mobile personal computer (UMPC), a netbook, or a personal digital assistant (PDA).

As shown in FIG. 7, the terminal 40 includes a memory 401, a display unit 402, and a processor 403. A person skilled in the art may understand that a structure of the terminal 40 shown in FIG. 7 constitutes no limitation on the terminal 40, and the terminal 40 may include parts more or fewer than those shown in FIG. 7, or a combination of some parts, or different part arrangements.

The following describes each integral part of the terminal 40 in detail with reference to FIG. 7.

The memory 401 may be configured to store a software program and a module, and the processor 403 executes various functional applications of the terminal 40 and data processing by running the software program and the module stored in the memory 401. The memory 401 may mainly include a program storage area and a data storage area, where the program storage area may store an operating system, and an application program required by at least one function (such as an audio play function and a video play function), and the like, and the data storage area may store data (such as audio data, video data, and a phone book) created according to use of the terminal 40, and the like. In addition, the memory 401 may include a high-speed random access memory (RAM), and may further include a non-volatile memory, such as at least one magnetic disk storage component, a flash memory component, or another volatile solid-state storage component.

The display unit 402 may be configured to display information input by the user or information provided for the user, and various menus of the terminal 40. The display unit 402 may include a display panel 4021, and optionally, the display panel 4021 may be configured in a form of a liquid crystal display (LCD), an organic light-emitting diode (OLED), and the like. Further, a touchscreen 4022 may cover the display panel 4021. When the touchscreen 4022 detects a touch operation on or near the touchscreen 4022, the touchscreen 4022 transmits the touch operation to the processor 403 to determine a type of a touch event, and then the processor 403 provides corresponding visual output on the display panel 4021 according to the type of the touch event. In FIG. 7, the touchscreen 4022 and the display panel 4021 are used as two independent parts to implement an input function and an output function of the terminal. However, in some embodiments, the touchscreen 4022 and the display panel 4021 may be integrated to implement the input function and the output function of the terminal 40.

The processor 403 is a control center of the terminal 40, connects to, by means of various interfaces and cables, various parts of an entire mobile phone, and executes, by running or executing a software program and/or a module that are/is stored in the memory 401 and by invoking data stored in the memory 401, various functions of the terminal 40 and data processing in order to perform overall monitoring on the terminal 40. Optionally, the processor 403 may include one or more processing units. Preferably, an application processor and a modulation and demodulation processor may be integrated into the processor 403, where the application processor mainly processes an operating system, a user interface, an application program, and the like, and the modulation and demodulation processor mainly processes wireless communication. It may be understood that the foregoing modulation and demodulation processor may either not be integrated into the processor 403.

The touchscreen 4022 is configured to detect whether a flick operation exists on the touchscreen.

The processor 403 is configured to determine, when the touchscreen 4022 detects the flick operation, whether the flick operation meets a preset condition.

The processor 403 is further configured to send a command to the display unit 402 such that the display unit 402 changes, corresponding to the flick operation, display content of a random N % zone in wallpaper displayed on the display panel 4021 when a flick operation is detected on the touchscreen 4022 and the flick operation meets the preset condition, where display content of another zone in the wallpaper except the N % zone remains unchanged, and N is an integer greater than or equal to 1, and less than or equal to 100.

The processor 403 is further configured to send a command to the display unit 402 such that the display unit 402 stops changing display content of the wallpaper, and presents a changed N % zone and a 100−N % zone that remains unchanged when it is detected that the flick operation stops.

The processor 403 is further configured to randomly change the wallpaper to another piece of wallpaper.

The processor 403 is further configured to send a command to the display unit 402 such that the display unit 402 changes at least one of the following parameters of the N % zone: a shape, a color, a size, or a location, and display a process of a dynamic change of the N % zone.

The processor 403 is further configured to send a command to the display unit 402 such that the display unit 402 randomly changes at least one of the following parameters of the N % zone: a shape, a color, a size, or a location, display a process of a dynamic change of the N % zone, and add a dynamic display pattern to the wallpaper.

The processor 403 is further configured to send a command to the display unit 402 such that the display unit 402 changes the wallpaper to random new wallpaper, and adds a dynamic display pattern to the new wallpaper.

According to the terminal of terminal wallpaper provided in the present disclosure, when the terminal detects a flick operation on the touchscreen and the flick operation meets a preset condition, the terminal changes, corresponding to the flick operation, display content of a random N % zone in wallpaper displayed on the touchscreen, where display content of another zone in the wallpaper except the N % zone remains unchanged. When the terminal detects that the flick operation stops, changing display content of the wallpaper is stopped, and a changed N % zone and a 100−N % zone that remains unchanged are presented. Therefore, different wallpaper may be presented for a user according to a user operation, and a changed zone and color are different each time the user flicks a screen. Different display effects are presented on static wallpaper that is set by the terminal.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A terminal wallpaper control method, applied to a terminal equipped with a touchscreen, comprising:
changing, by the terminal corresponding to a flick operation, display content of a random N % zone in a wallpaper displayed on the touchscreen when the terminal detects the flick operation on the touchscreen and the flick operation meets a preset condition, wherein display content of another zone in the wallpaper except the N % zone remains unchanged, and wherein N is an integer greater than or equal to 1 and less than 100;
stop changing display content of the wallpaper when the terminal detects that the flick operation stops; and
presenting a changed N % zone and a 100−N % zone that remains unchanged.

2. The method according to claim 1, wherein changing the display content of the random N % zone in the wallpaper displayed on the touchscreen comprises randomly changing, by the terminal, the wallpaper to another piece of wallpaper.

3. The method according to claim 1, wherein changing the display content of the random N % zone in the wallpaper displayed on the touchscreen comprises:
randomly changing, by the terminal, at least one of the following parameters of the N % zone:
a shape;
a color;
a size; and
a location; and
displaying a process of a dynamic change of the N % zone.

4. The method according to claim 1, wherein changing the display content of the random N % zone in the wallpaper displayed on the touchscreen comprises:
randomly changing, by the terminal, at least one of the following parameters of the N % zone:
a shape;
a color;
a size; and
a location;
displaying a process of a dynamic change of the N % zone; and
adding a dynamic display pattern to the wallpaper.

5. The method according to claim 1, wherein changing the display content of the random N % zone in the wallpaper displayed on the touchscreen comprises:
changing, by the terminal, the wallpaper to random new wallpaper; and
adding a dynamic display pattern to the new wallpaper.

6. A terminal equipped with a touchscreen, comprising:
a memory configured to store a software program;
a processor coupled to the memory, wherein the software program causes the processor to be configured to:
detect whether a flick operation exits on the touchscreen;
determine whether the flick operation meets a preset condition when detecting the flick operation;
change, corresponding to the flick operation, display content of a random N % zone in wallpaper displayed on the touchscreen when detecting the flick operation on the touchscreen and the flick operation meets the preset condition, wherein display content of another zone in the wallpaper except the N % zone remains unchanged, and wherein N is an integer greater than or equal to 1 and less than 100;
stop changing display content of the wallpaper when detecting that the flick operation stops; and
present a changed N % zone and a 100−N % zone that remains unchanged.

7. The terminal according to claim 6, wherein the software program further causes the processor to be configured to randomly change the wallpaper to another piece of wallpaper.

8. The terminal according to claim 6, wherein the software program further causes the processor to be configured to:
change at least one of the following parameters of the N % zone:
a shape;
a color;
a size; and
a location; and
display a process of a dynamic change of the N % zone.

9. The terminal according to claim 6, wherein the software program further causes the processor to be configured to:
randomly change at least one of the following parameters of the N % zone:
a shape;
a color;
a size; and
a location;
display a process of a dynamic change of the N % zone; and
add a dynamic display pattern to the wallpaper.

10. The terminal according to claim 6, wherein the software program further causes the processor to be configured to:
change the wallpaper to random new wallpaper; and
add a dynamic display pattern to the new wallpaper.

11. A computer program product comprising a non-transitory computer readable storage medium storing program code thereon for terminal wallpaper control, applied to a terminal equipped with a touchscreen, the program code comprising instructions for executing a method that comprises:
changing, by the terminal corresponding to a flick operation, display content of a random N % zone in a wallpaper displayed on the touchscreen when the terminal detects the flick operation on the touchscreen and the flick operation meets a preset condition, wherein display content of another zone in the wallpaper except the N % zone remains unchanged, and wherein N is an integer greater than or equal to 1 and less than 100;
stop changing display content of the wallpaper when the terminal detects that the flick operation stops; and
presenting a changed N % zone and a 100−N % zone that remains unchanged.

12. The computer program product according to claim 11, wherein changing the display content of the random N % zone in the wallpaper displayed on the touchscreen comprises randomly changing, by the terminal, the wallpaper to another piece of wallpaper.

13. The computer program product according to claim 1, wherein changing the display content of the random N % zone in the wallpaper displayed on the touchscreen comprises:
randomly changing, by the terminal, at least one of the following parameters of the N % zone:
a shape;
a color;
a size; and
a location; and
displaying a process of a dynamic change of the N % zone.

14. The computer program product according to claim 11, wherein changing the display content of the random N % zone in the wallpaper displayed on the touchscreen comprises:
randomly changing, by the terminal, at least one of the following parameters of the N % zone:
a shape;
a color;
a size; and
a location;
displaying a process of a dynamic change of the N % zone; and
adding a dynamic display pattern to the wallpaper.

15. The computer program product according to claim 11, wherein changing the display content of the random N % zone in the wallpaper displayed on the touchscreen comprises:
changing, by the terminal, the wallpaper to random new wallpaper; and
adding a dynamic display pattern to the new wallpaper.
